(19) United States
(12) Patent Application Publication
(10) Pub. No.: US 2007/0139155 A1
(43) Pub. Date: Jun. 21, 2007

(54) Humidity sensor and method for making the same

(75) Inventors: Ching-Hao Chung, Fongshan City (TW); Shih-Hung Yen, Pingdong City (TW); Wei-Cheng Chiou, Fongshan City (TW)

Correspondence Address: BACON & THOMAS, PLLC, 625 SLATERS LANE, FOURTH FLOOR, ALEXANDRIA, VA, 22314, US

(73) Assignee: Forward Electronics Co., Ltd., Taipei City (TW)

(21) Appl. No.: 11/411,116

(22) Filed: Apr. 26, 2006

(30) Foreign Application Priority Data
Dec. 15, 2005 (TW) 094144491

(51) Int. Cl. H01C 7/00

(52) U.S. Cl. 338/35

(57) ABSTRACT

A humidity sensor includes a substrate, at least two elongated electrodes formed respectively on the substrate where each of the elongated electrodes has a first end and a second end, at least a pair of comb-like electrodes each contacting with the first end of the elongated electrode, and a humidity sensitive film which contains hydrophilic ionic polymer and is formed respectively on the at least a pair of comb-like electrodes but not on the second ends of the elongated electrodes. In addition, the present invention further comprises a method for making such a humidity sensor.

### BACKGROUND OF THE INVENTION

1. Field of the Invention

The present invention relates to humidity sensors and, more particularly, to a humidity sensor with hydrophilic ionic polymer as humidity sensitive material, further including a method for making the same.

2. Description of Related Art

Following developments of technologies, many industrial fields such as medicine, agriculture, electronics, semi-conductors, and so forth, are in urgent need of humidity sensors. To the effect, as higher product qualities are demanded, controls on surrounding temperature and humidity, as well as monitoring and analysis on the moisture contained in industrial materials, have become significant criteria for technologies. “Humidity” is defined as the amount of moisture contained in the air. As far as an industrial process is concerned, a better humidity control is about between 0-20% relative humidity (RH). In case RH reaches 20%, medicines, foods, and semi-conductors begin to deteriorate; and when RH is around 35%, metals and electronics oxidize and decay, and the situation becomes more critical when humidity is up to 60% RH, where apparatuses for photograph, information, and optics, and paper and textiles as well, are moldy, and as a result become useless. Therefore, detection on humidity is significantly important.

Basically, a humidity sensor is made by coating a humidity sensitive material on a substrate so as to form a humidity sensitive film. Such a humidity sensor is derived from the principle that moisture affects electrical conductivity. Namely, when vapor in the air is absorbed by the humidity sensitive material, the electric resistance and dielectric constant of the humidity sensor vary greatly. A humidity sensor can also be used in a greenhouse to detect whether the air has been in a status of saturation and dew condensation.

In spite of the fact that presently application on humidity sensors for polymer falls behind those for metallic oxide, owing to rapid developments of polymer and IC manufacturing process where polymer has merits on high sensitivity, low cost and easy to make, humidity sensors of the type of polymer have been developed in a speedy extent. Examples can be found in Taiwan Patent Publication Nos. 507073 (corresponding to U.S. Patent Application Publication No. 2001/0037681) and 510965, where the former adopts a cross-linked product of a conductive polymer having ethylenically unsaturated groups; and the latter provides a humidity sensitive material which is modified from silane as a polymer of 2-acryl amido-2-methyl-propane sulfonic acid.

Taiwan Patent Publication No. 507073 (U.S. Patent Application Publication No. 2001/0037681) discloses a “Humidity Sensor and Method for Making” where the humidity sensor includes a pair of interdigital electrodes disposed on an insulating substrate and defining a gap therebetween, an undercoat layer of silane compound lying on the gap-defining electrodes and substrate, and a humidity sensitive thin film lying thereon. The humidity sensitive thin film is formed of a cross-linked product of a conductive polymer having ethylenically unsaturated groups, and physically bound to the undercoat layer through an interpenetrating polymer network. Further, Taiwan Patent Publication No. 510965 teaches dissolving silane compound into Si(OH)₄ , where the dissolved Si(OH)₄ is then added to 2-acryl amido-2-methyl-propane sulfonic acid, and after copolymerization, a modified 2-acryl amido-2-methyl-propane sulfonic acid can be obtained.

The above-mentioned humidity sensors made with such polymer materials are to some extent complicated in terms of steps and control conditions, and are questionable due to deterioration in high humidity environment, logarithm linearization and stability, and so forth.

### SUMMARY OF THE INVENTION

The object of the present invention is to provide a humidity sensor, including a substrate, at least two elongated electrodes formed respectively on the substrate where each of the elongated electrodes has a first end and a second end, at least a pair of comb-like electrodes each contacting with the first end of the elongated electrode, and a humidity sensitive film which contains hydrophilic ionic polymer and is formed respectively on the at least a pair of comb-like electrodes but not on the second ends of the elongated electrodes.

Another object of the present invention is to provide a method for making a humidity sensor, including the steps of: (a) providing a substrate having at least two elongated electrodes where each of the elongated electrodes has a first end and a second end; (b) forming on the substrate at least a pair of comb-like electrodes, separate from each other and each contacting with the first end of the elongated electrode; and (c) dipping the comb-like electrodes in a solution of humidity sensitive material so as to form a humidity sensitive film, where the humidity sensitive material contains hydrophilic ionic polymer.

The humidity sensor according to the present invention relates to a humidity sensor of the type of electric resistance, of which electric resistance varies logarithm linearly following the changes of relative humidity in surroundings, thereby control signals are fed into electric appliances, such as dehumidifiers and air conditioners, for controlling and regulating the relative humidity of surroundings.

Substrates suitably used in the humidity sensor according to the present invention can be of any conventional kinds, for example, a ceramic substrate, a bakelite substrate or a fiberglass substrate, and preferably a ceramic substrate with a pair of electrodes. Electrodes can be of any electric-conductive material such as a gold gel, a silver gel or a carbon gel, preferably a silver gel, and more preferably a silver gel of fiberglass gel series. The comb-like electrodes formed on the substrate according to the present invention can be of any electric-conductive material, such as gold gel, silver gel or carbon gel, and preferably carbon gel.

The humidity sensitive material for use in the humidity sensor according to the present invention can be of any kind of hydrophilic ionic polymer, such as the polymers constituted by ionic-bonding monomers of Sulfonic group (—SO₃H), Hydroxyl group (—OH) or Carboxyl group (—COOH), and preferably the polymer containing Sulfonic group, and more preferably Sodium Polystyrenesulfonate (NaPSS).

In the method of making a humidity sensor according to the present invention, step (b) in forming the comb-like electrodes can be of any conventional kind, and preferably by screen-printing. Whereas after finishing step (b), and prior to step (c), an additional step (b1) in drying the substrate may be included, so that the electric-conductive gel of the comb-like electrodes applied on the substrate can be fully affixed to the substrate. Similarly, after finishing step (b), and prior to step (c), an additional step (b1) in drying the substrate may be included.

Other objects, advantages, and novel features of the present invention will become more apparent from the following detailed description when taken in conjunction with the accompanying drawings.

### BRIEF DESCRIPTION OF THE DRAWINGS

FIG. 1 is a plan view of a humidity sensor according to the present invention; and

FIG. 2 is a graph showing resistance versus relative humidity for the humidity sensor according to the present invention.

### DETAILED DESCRIPTION OF THE PREFERRED EMBODIMENT

Preparation

Selection on humidity sensitive material: A powder of Sodium Polystyrenesulfonate (NaPSS) is selected to mix with water which are then agitated to become a solution. Such a humidity sensitive material relates to an ionic polymer and is hydrophilic. The humidity sensitive material dissociates when encountering moisture, and after dissociation, electric-conductivity occurs due to the flow of ions.

Making of silver electrodes: Adopting a screening-printing measure to print silver gel of glass fiber gel series onto a ceramic substrate, then sintering the silver gel at 850° C. in a sintering stove such that with 50 minutes of progressive heating stage up to 850° C. and 10 minutes of constant heating stage at 850° C., so as to form soldering ends of silver electrodes.

Making of comb-like electrodes: Adopting a screening printing measure to print prepared carbon gel onto a ceramic substrate, where four pairs of comb-like electrodes, which intercross from but not contact with each other, are formed at one end of the pattern being printed, and the other end of the printed pattern is connected to the silver electrodes, and after baking for 8 minutes at 230° in an infrared-rays drying oven, the comb-like electrodes are cured.

Making of carbon gel: Using a tri-roller grinding and dispersing machine to disperse uniformly carbon black, graphite, phenolic resin and alkanol solvent, which then are condensed to form a weight of 25% carbon powder, 65% phenolic resin, and 10% alkanol solvent.

Making of humidity sensitive material solution: Putting NaPSS polymer powder into pure water so as to make the weight reach 1.5%-2%, which are then agitated by a heating agitator until NaPSS polymer powder has dissolved in the water completely.

### Embodiment

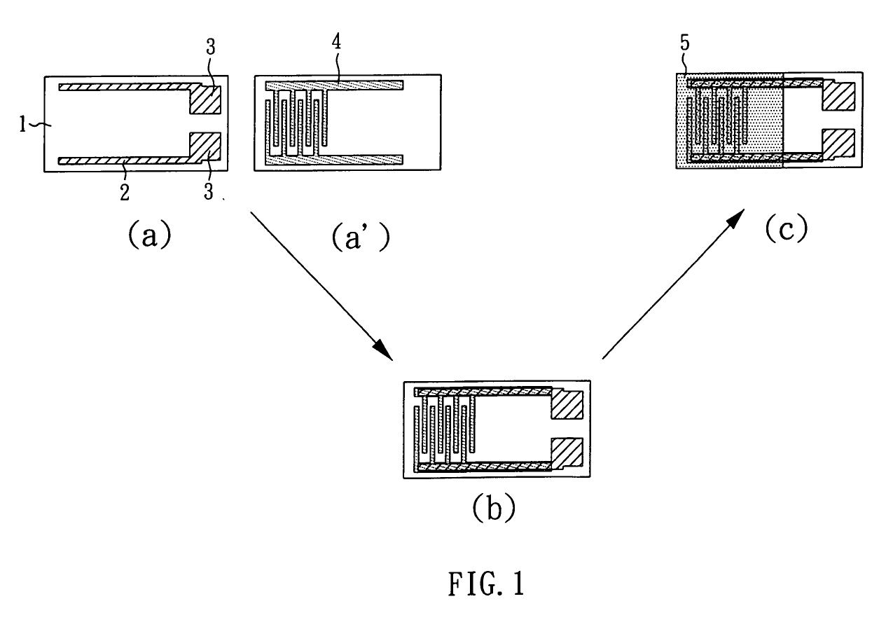

FIG. 1 shows a manufacturing process of the humidity sensor according to the present invention. First, a screen-printing measure is employed to print silver electrodes 2 onto a ceramic substrate 1 (Al₂O₃), as shown in FIG. 1a, wherein the thickness of the ceramic substrate is 0.635 mm, with a dimension of 10.4×5.1 mm; then a screen-printing measure is introduced to print carbon gel onto the ceramic substrate 1 so as to form with comb-like electrodes 4, as shown in FIG. 1a′; thereafter the ceramic substrate 1 is put into the water in a supersonic cleaner for 5 minutes of cleaning in vibration, and dried in a warm-air drying oven for 30 minutes at 50° C., as shown in FIG. 1b, and then dip the comb-like electrodes 4 of the ceramic substrate 1 into the humidity sensitive material solution for about 10 minutes (with the comb-like electrodes 4 completely submerged and the soldering ends 3 of the silver electrodes 2 not submerged); and then the ceramic substrate 1 is dried in the warm-air drying oven for 10 minutes at 50° C., so that transparent humidity sensitive film 5 can be formed at a location of the ceramic substrate 1 where the humidity sensitive material solution submerges, as shown in FIG. 1c.

Evaluation on the Humidity Sensor

Dispose the humidity sensor according to the present invention in a testing machine maintaining constant humidity and constant temperature at 25° C. where an LCR meter (setting at 1.0V, 1000 Hz) is connected to the soldering ends 3 of the silver electrodes 2 so as to measure the resistance of the humidity sensor at relative humidity (RH) readings of 20%, 30% and . . . up to 90%. In a logarithm table showing humidity versus resistance of a humidity sensor, where variation of the resistance appears linearly. The test results, as shown in Table 1, show the resistance varied according to the humidity at 30%, 40% . . . and 90% (the unit for resistance is KΩ).

TABLE 1

| | RH (%) | | | | | | |
|---|---|---|---|---|---|---|---|
| NO. | 30% | 40% | 50% | 60% | 70% | 80% | 90% |
| 1 | 1050 | 235 | 91 | 32 | 12 | 6.5 | 4.65 |
| 2 | 710 | 155 | 60 | 23 | 8.4 | 4.6 | 3.46 |
| 3 | 820 | 190 | 73 | 25 | 9.6 | 4.7 | 3.95 |
| 4 | 785 | 185 | 70.5 | 25 | 9.6 | 5.7 | 4.13 |
| 5 | 860 | 198 | 76 | 26 | 10.1 | 5.7 | 4.0 |
| 6 | 770 | 179 | 67.5 | 23 | 9.4 | 5.0 | 3.3 |
| 7 | 740 | 169 | 62.5 | 21 | 8.4 | 5.0 | 3.33 |
| 8 | 715 | 170 | 64.5 | 23 | 8.7 | 5.3 | 3.63 |
| 9 | 695 | 164.5 | 61 | 22 | 8.4 | 5.3 | 3.93 |
| 10 | 855 | 200.5 | 77 | 27 | 10.1 | 5.7 | 3.98 |
| 11 | 1060 | 242 | 87.5 | 28 | 10.7 | 5.5 | 3.08 |
| 12 | 750 | 173 | 64 | 21 | 8.5 | 5.0 | 3.5 |
| 13 | 840 | 196 | 76.6 | 24 | 10.1 | 5.7 | 3.96 |
| 14 | 850 | 195 | 70 | 22 | 9.1 | 5.2 | 3.64 |
| 15 | 860 | 204.5 | 73 | 25 | 9.6 | 5.2 | 3.22 |
| 16 | 945 | 226 | 80 | 28 | 10.7 | 6.1 | 4.17 |
| 17 | 955 | 237 | 85 | 29 | 10.6 | 6K | 4.14 |

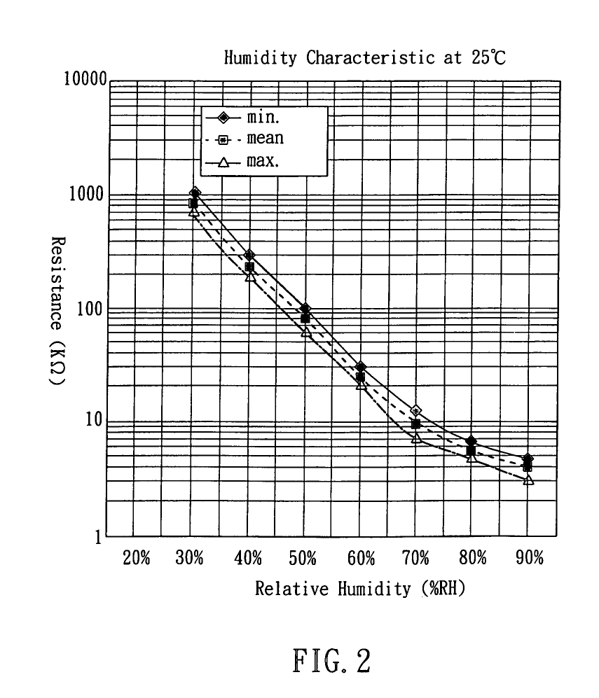

Further, taking the maximum value (Max.), mean value (Mean) and minimum value (Min.) respectively from the values at 30%, 40% . . . and 90% of the relative humidity readings mentioned in Table 1, Table 2 can be obtained, and so FIG. 2 which shows a logarithm of resistance versus relative humidity. It is therefore understood from FIG. 2 that the more the relative humidity is, the lower the resistance will be, and that a logarithm linearity relationship is formed for the relative humidity versus the resistance. FIG. 2 indicates that the humidity sensor according to the present invention has merits both on logarithm linearity and stability, and as such, relative humidity in the surroundings can be well controlled and regulated by feeding back such a result in controlling signals.

TABLE 2

| | RH (%) | | | | | | |
|---|---|---|---|---|---|---|---|
| R (KΩ) | 30% | 40% | 50% | 60% | 70% | 80% | 90% |
| Max. | 1060 | 290 | 91 | 32 | 12 | 6.5 | 4.65 |
| Mean | 839 | 230 | 73 | 25 | 9.6 | 5.5 | 3.8 |
| Min. | 695 | 190 | 61 | 21 | 7.1 | 4.6 | 3.08 |

Although the present invention has been explained in relation to its preferred embodiments, it is to be understood that many other possible modifications and variations can be made without departing from the scope of the invention as hereinafter claimed.

What is claimed is:

1. A humidity sensor, comprising:
a substrate;
at least two elongated electrodes, formed respectively on the substrate where each of the elongated electrodes has a first end and a second end;
at least a pair of comb-like electrodes, each contacting with the first end of each elongated electrode; and
a humidity sensitive film, containing hydrophilic ionic polymer and formed respectively on the at least a pair of comb-like electrodes but not on the second ends of the elongated electrodes.

2. The humidity sensor as claimed in claim 1, wherein the substrate is a ceramic substrate.

3. The humidity sensor as claimed in claim 1, wherein the at least two elongated electrodes are silver electrodes.

4. The humidity sensor as claimed in claim 1, wherein the second ends of the at least two elongated electrodes are soldering ends of the silver electrodes.

5. The humidity sensor as claimed in claim 1, wherein the comb-like electrodes contain carbon gel.

6. The humidity sensor as claimed in claim 1, wherein the comb-like electrodes are formed as four pairs of comb-like electrodes.

7. The humidity sensor as claimed in claim 1, wherein the material of the humidity sensitive film containing hydrophilic ionic polymer is Sodium Polystyrenesulfonate (NaPSS).

8. A method for making a humidity sensor, comprising the steps of:
(a) providing a substrate having at least two elongated electrodes where each of the elongated electrodes has a first end and a second end;
(b) forming at least a pair of comb-like electrodes on the substrate, separate from each other and each contacting with the first end of the elongated electrode; and
(c) dipping the comb-like electrodes in a solution of humidity sensitive material so as to form a humidity sensitive film, where the humidity sensitive material contains hydrophilic ionic polymer.

9. The method as claimed in claim 8, wherein the substrate is a ceramic substrate.

10. The method as claimed in claim 8, wherein the elongated electrodes are silver electrodes.

11. The method as claimed in claim 8, wherein the second ends of the at least two elongated electrodes are soldering ends of the silver electrodes.

12. The method as claimed in claim 8, wherein the comb-like electrodes contain carbon gel.

13. The method as claimed in claim 8, wherein the comb-like electrodes are formed as four pairs of comb-like electrodes.

14. The method as claimed in claim 8, wherein the hydrophilic ionic polymer is Sodium Polystyrenesulfonate (NaPSS).

15. The method as claimed in claim 8, wherein the comb-like electrodes are formed by screen-printing.

16. The method as claimed in claim 8, wherein after finishing step (b), and prior to step (c), an additional step (b1) in drying the substrate is included.

17. The method as claimed in claim 8, wherein after finishing step (c), an additional step (c1) in drying the substrate is included.
